(19) United States
(12) Patent Application Publication
(10) Pub. No.: US 2021/0227788 A1
(43) Pub. Date: Jul. 29, 2021

(54) Predator Deterring Vest

(71) Applicants: Paul Mott, San Diego, CA (US); Pamela Mott, San Diego, CA (US)

(72) Inventors: Paul Mott, San Diego, CA (US); Pamela Mott, San Diego, CA (US)

(21) Appl. No.: 17/160,167

(22) Filed: Jan. 27, 2021

Related U.S. Application Data
(60) Provisional application No. 62/966,399, filed on Jan. 27, 2020.

(51) Int. Cl. A01K 13/00

(52) U.S. Cl. CPC A01K 13/006

(57) ABSTRACT

A collar is provided for protecting animals from neck bites from predators. The collar is formed of individual segments in pivoting engagements with each other and has a fastener to engage a first end to a second end of the collar. Contact between opposing edges of each engaged segment prevents collapse of the collar and maintains the size or distance of the interior diameter of the collar during predator attacks which impart force to opposing sides of the collar.

This application claims priority to U.S. Provisional patent Application Ser. No. 62/966,399, filed on Jan. 27, 2020, which is incorporated herein in its entirety by this reference thereto.

### 1. FIELD OF THE INVENTION

The present invention relates generally to the protection of animals which are pets such as dogs and cats, and other domesticated animals which are at risk from predator attacks. More particularly, the invention relates to a collar configurable to multiple sizes through the engagement of a plurality of pointed collar segments. So configured, the engaged collar segments resist collapse and have pointed portions. Each section will cause pain to the predator attempting to bite the animal wearing it. In one mode the collar illuminates in colors and sequences to scare or dazzle the vision of the predator.

### 2. Prior Art

The human population, in many countries worldwide, continues to expand their living area into populations outside cities. This expansion has in turn caused area occupants of cities as well as small towns, to build homes in areas which have been previously unpopulated or sparsely populated areas. An unintended consequence of this population expansion has caused a collision between humans and wild animals who previously lived in such unpopulated areas.

Conventionally, wild animals tend to avoid humans if at all possible. They, thus, will migrate away from expanding human populations. However, some wild animals have adapted to live or hunt in the housing areas within and surrounding cities and small towns. Such predators as coyotes, and more recently in many states, bears and mountain lions and the like, have realized that pets and domestic animals frequently accompany humans to these expanding homes and housing tracts. In short order such predatory animals have ascertained that pets and domestic animals accompany humans and that they are an easy target for a meal.

Some predatory animals such as raccoons and coyotes have taken up residence in outlying areas from cities and even within cities because they have learned that domesticated animals are an easily captured food source. Still further, for small dogs and cats and other animals, birds of prey such as hawks and owls are an ongoing threat as such birds are widely known to prey on pets in aerial attacks.

Such predatory practices of wild animals surrounding and living within areas occupied by humans have caused owners to seek to protect their pets and domesticated animals from such predator attacks such as fences and outdoor lighting. However, cunning predatory animals, in particular coyotes, have adapted well to urban life and actually choose to live in parks and areas surrounding rivers and lakes within the actual boundary of cities and towns. Because of their ongoing proximity to humans and the learned behavior that pets and domesticated animals frequently accompany humans, predators living within urban areas as well as areas surrounding human populations, have become less afraid of humans and more interested in an easy meal.

Indeed, daily news reports in the United States tell the story of pets such as dogs and cats being attacked by coyotes even while the pet is being walked by their human owner. Such has resulted in the horrible outcome of a human pet owner visually witnessing the demise of their beloved pet companion.

The forgoing examples of related art concerning predator attacks and limitations related therewith, are intended to be illustrative and not exclusive, and they do not imply any limitations on the invention described and claimed herein. Various other limitations of the related art are well known or will become apparent to those skilled in the art upon a reading and understanding of this specification and the accompanying drawings.

### SUMMARY OF THE INVENTION

The collar device herein disclosed and described provides a wearable means for protection of pets and domestic animals from predators such as wolves, mountain lions, and in particular, due to their propensity to hunt in urban areas, coyotes. The collar device herein is formed of a plurality of pivotally engaged collar segments. Using more or less of such segments to form a collar assembly, the user may easily assemble a resulting collar in larger or smaller sizes, which are configured in size to engage upon a chosen pet or domesticated animal.

The collars so assembled provide concurrent means for dissuading or preventing predator attacks on pets wearing them. First, each collar segment is formed with a pair of pointed projections on opposing sides of a central area of the segment. When in respective pivoting connections to other collar segments forming the collar, sharp pointed projections will encircle the entire neck of the pet or animal wearing the formed collar.

Since predators such as coyotes and mountain lions will usually attack the neck of their intended prey, an attempted bite of the neck of the animal wearing the formed collar herein, will cause significant pain or injury to the mouth of the attacking animal from the sharp spikes or pointed edges of each segment. Such will cause an immediate release of the bite by the predator thereby protecting the animal wearing the formed collar as well as giving them time to escape.

The collar segments are formed in a fashion where each segment is pivotally engaged to an adjacent segment, using the number of segments which form a collar having an interior diameter sized to comfortably engage around the neck of a pet or other animal. So engaged, central portions of each of the segments form a compression resistant encirclement of the neck of the pet or animal in that the pivotally engaged collar segments prevent collapse of the interior of the formed collar from the diameter thereof when engaged around the neck of an animal. Thus, the predator attempting to bite the wearer will be prevented from compressing that bite around the neck of the wearer by the abutting central sections of the assembled collar segments. Concurrently, the sharp points on opposing sides of the central section of each segment will contact the skin and gums of the attacking predator and cause them pain and injury.

The collar segments are preferably formed of a material which will not easily bend or crack such as glass particle reinforced polymeric material, fiberglass, composite material of a resin reinforced with glass or other fibers, or a similar material which those skilled in the art will discern will resist compression and breaking under compression. The pivoting engagements allow the central portions of the body of each respective segment to operatively work with an adjacent segment to form a compression resistant ring on the interior circumferential surface of the assembled collar.

In a second concurrent means to dissuade predators from attacking the animal wearing the assembled collar, the collar formed of segments may have onboard means for illumination of those segments. This illumination can be from bright LEDs or other light emitters positioned around the circumference of the formed collar. In a particularly preferred mode of the device, the light emitters will be operatively engaged to a power source and also be operatively controlled by a controller. The controller can switch the individual light emitters to blink or to illuminate in a sequential lighting around the collar or in other sequences or blinking timing.

The light emitters such as LEDs may be programmable using a controller enabling the emitters such as LEDs to emit any color in any sequence of lighting on or around the collar. Using a wireless connection to the onboard controller, the colors and sequences can be controlled remotely with software running on a computer or smart phone. Preferably the electric power source is a rechargeable battery that is integrated with the collar.

Additionally, the emission of light by the emitters such as LEDs can be programmed to provide additional protection against predators by employing light emission patterns that induce anxiety, and/or bright flashes that overload optical receptors of the eyes of the predator causing temporary blindness during the recovery time from which, the animal can escape. For holidays and celebrations, emission from the light emitters can be programmed for entertainment so that they provide fun and colorful light patterns including popular holiday colors. In all modes of the device, the body of the segments forming the collar is made with translucent materials that disperse the light evenly.

Thus, the bright illumination, blinking, and/or sequential illumination of adjacent light emitters will provide a means to dazzle the attacking predator and employed concurrent with the compression resistant collar, and sharp points of contact which cause the predator pain, the collar provides protection enhanced by the concurrent repellants, to ward off the attack.

Optionally, the collar device can include electronic sensors so that the controller is informed when an external surface is being touched by human or animal. Using such sensors the collar can react accordingly with additional light, sound, or even an electrical shock.

It should be noted that any of the described means to dissuade predator attacks of the collar device above can be employed alone, or in combination with any other of the dissuading components. Such will allow the collar to be configured in a fashion most likely to prevent harm to the pet based on the locale and the knowledge of the owner as to local predators. However, working together in symbiotic fashion, the pointed edges, non collapsible formation, and light emission causing a dazzle effect to the attacker provide a significantly enhanced means of dissuading predator attacks.

With respect to the above description of the predator dissuading collar device and method herein, before explaining at least one preferred embodiment of the herein disclosed invention in detail, it is to be understood that the signaling invention is not limited in its application to the details of construction and to the arrangement of the components or steps noted in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other collared structures, methods and systems for carrying out the several purposes of the present disclosed device to provide a wearable predatory dissuading collar for animals. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” if not otherwise defined herein, means plus or minus ten percent.

The objects features, and advantages of the present predator dissuading collar invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative of the device rather than limiting. In the drawings:

FIG. 1 shows an overhead or plan view of the collar device herein formed of individual pivotally engaged collar segments having pointed sidewalls forming spikes on opposing sides of a central body portion.

FIG. 2 depicts a collar segment as assembled in FIG. 1 showing the spikes formed on opposing sides of a central body portion of the collar segment and having apertures or openings on a first end and aperture-engaging projections on the opposite or second end.

FIG. 3 is a perspective view of the collar device of FIG. 1, showing the central body portions of the plurality of pivotally engaged segments forming a compression resistant interior wall, and showing light emitters positioned on or within the body of the segments.

FIG. 4 depicts the device, as in FIG. 1, showing the two ends of the formed collar engaged with a fastener and showing the interior diameter of the collar formed by the plurality of central body portions which when so engaged resist compression to thereby maintain the diameter distance.

FIG. 5 shows a segment of the device which includes electric connections at opposing ends to allow segments to be added or subtracted and still maintain the electric connection around the formed collar.

FIG. 6 depicts a sectional view across line 6-6 of FIG. 5, and shows the preferred concave sides of the formed spikes which are formed by inwardly curving concave sides of each spike.

Other aspects of the present disclosed collar invention shall be more readily understood when considered in conjunction with the accompanying drawings, and the following detailed description, neither of which should be considered limiting.

### DETAILED DESCRIPTION OF THE PREFERRED

### Embodiments of the Invention

In this description, the directional prepositions of up, upwardly, down, downwardly, front, back, top, upper, bottom, lower, left, right and other such terms refer to the device as it is oriented and appears in the drawings and are used for convenience only. Such prepositions are not intended to be limiting or to imply that the device has to be used or positioned in any particular orientation.

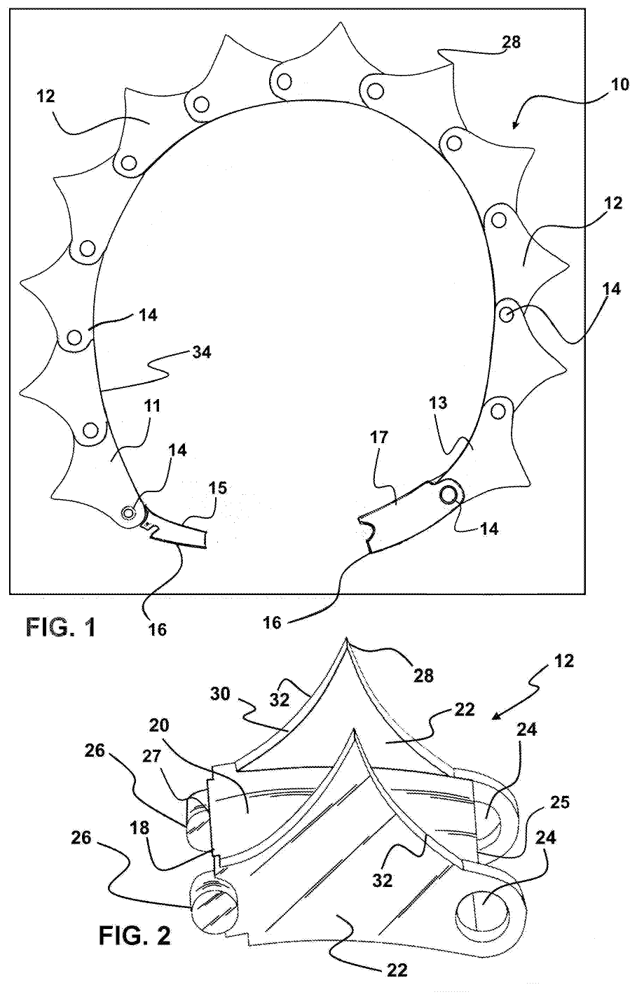

Now referring to drawings in FIGS. 1-6, there is depicted in FIG. 1 an overhead or plan view of the collar device 10 herein. As shown and in all modes herein, the collar device 10 is formed of a plurality of sequentially connected collar segments 12, each being in a pivoting engagement 14 with adjacent collar segments 12 forming the collar. The formed collar device 10, thus, has a plurality of segments 12 engaged and extends from a first segment 13 at a first end to a last segment 13 at an opposite second end.

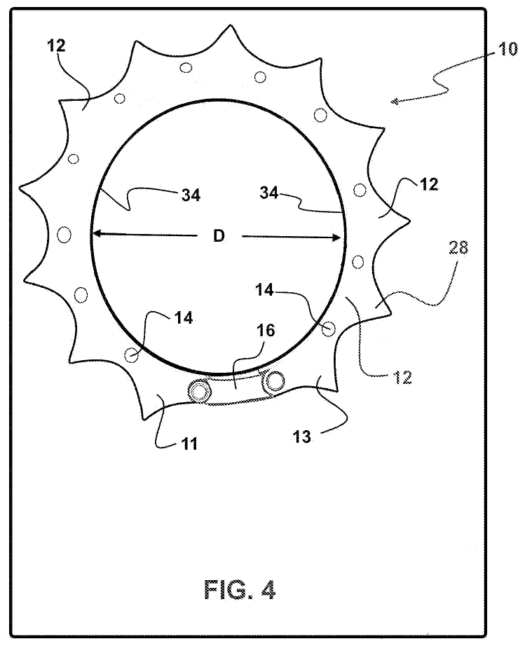

As shown in FIG. 1, the formed collar device 10 also has a separable fastener 16. The separable fastener has a first fastener component 15 in a pivoting engagement 14 with the first segment 13, and has a second fastener component 17 in a pivoting engagement 14 with the last segment 13 of the sequentially engaged segments 12. The separable fastener 16, once the first and second components thereof are engaged, forms the collar device 10 to a compression resistant structure as in FIG. 4, wherein the interior diameter “D” is maintained by the compression resistant configuration of engaged segments 12.

As shown in the figures, and in an enlarged fashion in FIG. 2, each segment 12 is formed of a body 18 preferably formed as a unitary structure for strength. The body 12 has a central portion 20 positioned between two sidewalls 22. The central portion 20 extends from a first end 25 located between a pair of openings 24 to a second end 27 in between a pair of projections 26. The projections 26 of each segment are sized for a rotational engagement within the openings 24 projecting from an adjacent segment 12 in the sequentially engaged segments 12 forming the collar device 10.

At least one and preferably both sidewalls 22, project above the central portion 20 of the body 18 on opposing sides of the central portion 20. The sidewalls 22 extend away from the central portion 20 to form points defining spikes 28 at a peak of the narrowing projection of each sidewall 22. Preferably the distal edge 30 of each projecting sidewall 22 has a beveled edge or concave or inwardly curved portion 29 (FIG. 6) of the sidewall 22, located on opposing sides of the pointed portion of the distal edge 20 defining the pointed spike 28. This curved portion 29 is preferred rather than a linear edge, because it has been found to significantly increase the strength of the projecting sidewall 22 to resist breaking when compressed. As noted herein, the concave curve also serves to increase the cutting ability of the spikes 28 to thereby dissuade predators from biting.

Additionally preferred where the curved portions 29 are not employed, at least a single beveled edge 32 runs along one side surface of the distal edge 30 of the projecting sidewall 22. This beveled edge 32 has also been found to enhance the puncture ability of each formed spike 18 along the curved distal edge 30 the cause pain first, and injury second, to a predator engaging in a compressive bite around the collar device 10 when operatively engaged around the neck of an animal.

The body 18, as noted, is preferably formed of a unitary structure which will retain its form even under compressive forces of a bite. Currently preferred is a body 18 which includes glass fiber reinforced polymeric or plastic material, or reinforcement with fiberglass, or other material, which will prevent the body 18 or portions thereof from cracking or breaking under compressive force. A body 12 formed of carbon fiber would also work well to maintain its form under compression.

The portions of the body 18 having the openings 24, such as in the sidewalls, are formed of a thickness to flex slightly and thereby allow the user to engage the projections 26 of an adjoining body 18 into the openings 24 of the adjacent body 12 in the sequential engagement forming a collar device 10. Once so engaged the formed pivoting engagement 14 is not easily disengaged. This thickness may vary, for example but in no way limiting, from 1/16 inches to ½ inches, depending upon the material employed to form the body such as polyethylene or polypropylene or other polymeric fiber or glass reinforced materials.

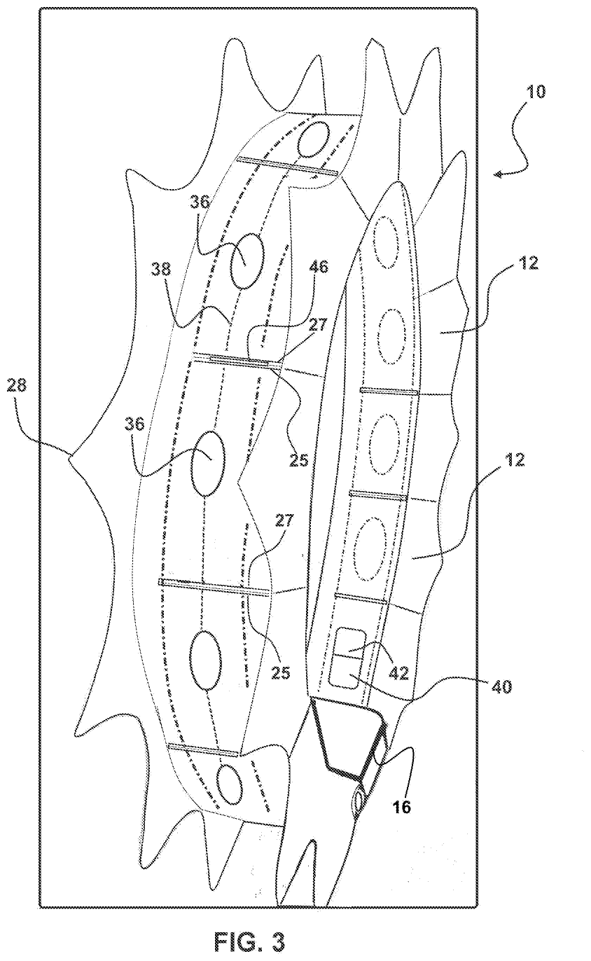

As depicted in FIG. 3, the device 10 is shown with sequentially engaged segments 12 and formed to a collar which resists collapse. Both the first end and second end of the formed collar device 10 are connected by the removably engaged component of the separable fastener 16, to thereby form a collar having a fixed interior diameter D as in FIG. 4.

This separable fastener is currently formed by a first fastener component 15 and second fastener component 17 (FIG. 1). The first fastener component 15 has projections 26 on one end which engage to the openings 24 of first segment 13 to which it engages. The second fastener component 17 has openings 24 on one end which rotationally engage to the projections 26 of the last segment 13 in the sequentially engaged segments 12, to which it engages.

As noted, compressive force upon opposing sides of the formed collar device 10, once the two ends are engaged by the fastener 16, will substantially maintain the diameter D formed by the interior contact surfaces 34 of each body 18 of each of the sequentially connected segments 12.

This is because with the openings 24 rotationally engaged upon the projections 26 of each pivoting engagement 14 of each adjacently positioned fastener segment 12, a first edge 25 of the body 18 abuts and under compressive force contacts against, a second edge 27 of the adjacent sequentially engaged segment 12. Further, when the first fastener component 15 is operatively connected to the second fastener component 17, the engaged fastener 16 operates the same as a segment 12. Once the fastener 16 components are connected, a first edge 25 located on the second fastener component 17 contacts against the second edge 27 of the adjacent segment 12, and a second edge 27 located on the first fastener component 15, abuts and contacts against a first edge 25 located on the segment 12 to which it is engaged.

Thus, compressive force imparted to two sides of the formed device 10, such as by a predator bite, is resisted by the encircled pivoting engagement 14 of each of the segments 12 and the respective fastener component, upon the projections 26 of the adjacent segment 12. During this encircled pivoting engagement 14 of all the sequential segments 12 forming the collar device 10, upon such compressive force, the first edge 25 located between the two openings 24 of each segment 12, contacts against the second edge 27 of the adjacent segment body 18 running between the two projections 26. During such contact with the openings 24 engaged to the projections 26, and the fastener 16 engaged, the collar 10 will resist compressive force and maintain the diameter D, and protect the animal wearing it, from compressive force harm.

Also shown in FIG. 3 are light emitters 36 positioned on or within the body 18 of at least one, but preferably a plurality of the sequentially engaged segments 12 forming the collar device 10. An electric connection 38 is in electric communication with each light emitter 36, and with a power source such as a battery (not shown but well known) which for example may be positioned on the fastener 16. Preferably a controller 40 is operatively engaged with the electric connection 38 in a manner to allow for concurrent illumination of all of the emitters 36, and/or blinking thereof, and/or sequential illumination of each of the light emitters 36 around the encircled collar device 10.

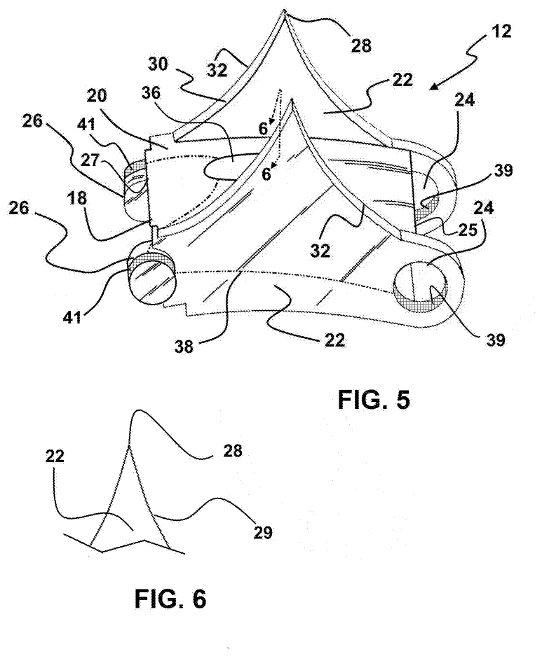

In all modes of the device 10, it is most preferable that the size of the collar device 10, and thus the diameter D, can be adjusted by adding and/or subtracting segments 12. Where illumination is employed, each of the segments 12, can be configured to maintain an electric connection 38 with the adjacent two segments 12 such as in FIG. 5.

As shown in FIG. 5, a first electric contact 39 is positioned within the openings 24 and is engaged with the electrical connection 38. A second electric contact 41 is positioned on one or both projections 26, and is also in operative engagement to the electrical connection 38. This same electric connection can run through the two portions of the fastener 16 and the respective openings 24 and projections 26 thereof.

These electric connections 39 and 41 may be formed of a conductive material such as copper or aluminum or even steel. As can be discerned, upon the engagement of each sequential segment 12 or the fastener components, to an adjacent segment 12, the electric connection 38 will communicate through the first electric contact 39 in rotational communication with the second electric contact 41, and through the electrical connection 38 of each segment 12 to the appropriate light emitter 36 or a sound emitter or the like if used in place thereof.

A compression sensor 46 (FIG. 3) may be engaged to the device 10, such as in-between the first and second edges 25 and 27 of two adjacent segments 12. The compression sensor 46 will be placed in electric communication with the controller 40, such that when a predator is biting the device 10 and causing compression, the light brightness, or sequence, or color, or blinking duration can change. Further, the controller can be connected to a sound emitter 42 which can be activated upon such compression sensing, to emit a loud sound, or a sound at a frequency known to be painful or disliked by predators, concurrent with the light emitted by the light emitters 36.

Shown in FIG. 4, is a perspective view of the collar device 10 in a sequentially engaged configuration where the first segment 13 at the first end, and the last segment 17 at the second end of the collar, are in respective pivoting engagements 14 to the first and second fastener components of the separable fastener 16. As noted, when so engaged, the interior diameter D of the formed collar device 10, is substantially maintained, even when the device 10 is subjected to compressive pressure from the bite of a predator. With the device 10 engaged around the neck of a pet or animal, the predator will be unable to compress the neck of the wearer thereby maintaining both the blood circulation and the breathing air pipe of the animal during the attack and preventing injury.

As noted above, in FIG. 5 is shown a segment 12 of the device 10 which includes a first electric contact 39 and a second electric contact 41 positioned at opposing ends of the body 18. As also noted, these electric contacts allow segments 12 to be added or subtracted from the collar device 10 and still maintain the electric connection 38 running around the formed collar and to the various electric powered components noted herein.

In FIG. 6 is shown a sectional view across line 6-6 of FIG. 5. As shown, the curve of the curved portions 29 at the distal edge of the sidewalls 22 forming the spike 28, is concave. It has been found in experimentation over time, that this concave configuration with both curved portions 28 curving inward, that the spikes 28 are more effective in dissuading a predator biting the collar device 10 to stop.

While all of the fundamental characteristics and features of the predator protecting collar for pets and animals have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An apparatus for protecting animals from predators, comprising:
a collar, said collar formed of individual collar segments, each of said collar segments having a body, said body having a first end opposite a second end thereof;
said collar having a first of said collar segments positioned at a first end of said collar and having a last said collar segments positioned at a second end of said collar;
a plurality of said collar segments positioned in a central area of said collar, in between said first collar segment and said last collar segment;
each of said collar segments in said central area of said collar having a first pivoting engagement to a first end of said body of an adjacent said collar segment;
each of said collar segments in said central area of said collar having a second pivoting engagement to said second end of said body of an adjacent said collar segment;
a second end of said first collar segment in a said pivoting engagement with a respective first end of said body of an adjacent one of said collar segments in said central area;
a first end of said last of said collar segments in a said pivoting engagement with a respective first end of said body of an adjacent one of said collar segments in said central area;
a first fastener component having a pivoting connection of a second end thereof, to a first end of said body of said first collar segment;
a second fastener component having a pivoting connection of first end thereof, to a second end of said body of said last collar segment;
a first end of said first fastener component being removably engageable to a second end of said second fastener component to thereby form said collar to an engaged configuration, with said first end of said first end of said collar removably connected to said second end of said collar;
said collar surrounding an opening having a diameter distance, said diameter distance of said opening configuring said collar for positioning around the neck of an animal to be protected from a predator;
an insertion or removal of one of said plurality of said collar segments positioned in said central area of said collar providing a length adjustment of said collar; and
said length adjustment providing for a change in said diameter distance.

2. The apparatus for protecting animals from predators, of claim 1 additionally comprising:
each said body having a central area extending between a first edge at said first end of said body and a second edge at said second end of said body;
each said segment having a first sidewall extending above said central area to a first spike at a distal edge of said first sidewall;
each said segment having a second sidewall extending above said central area opposite said first sidewall, each said second sidewall extending to a second spike at a second distal edge of said second sidewall; and
each said first spike and said second spike configured to pierce portions of a mouth of a predator contacting it during an attempt to bite an animal wearing said collar.

3. The apparatus for protecting animals from predators, of claim 1 wherein each said pivoting engagement comprises:
a pair of openings positioned at said first end of said body; and
a pair of projections, one each of said pair of projections in a rotating connection with a respective one said pair of openings.

4. The apparatus for protecting animals from predators, of claim 2 wherein each said pivoting engagement comprises:
a pair of openings positioned at said first end of each said body; and
a pair of projections positioned at a second end of each said body; and
one each of said pair of projections in a rotating connection with a respective one said pair of openings.

5. The apparatus for protecting animals from predators, of claim 2 additionally comprising:
said collar in said engaged position locating a said first edge of a body of each said segments in contact with a respective said second edge of an adjacent said body of an adjacent said segment; and
said contact between respective said first edges with respective said second edges defining a support preventing said collar from bending into said opening, whereby a distance of said diameter distance is maintained upon forces imparted to opposing sides of said collar.

6. The apparatus for protecting animals from predators, of claim 3 additionally comprising:
said collar in said engaged position locating a said first edge of a body of each said segments in contact with a respective said second edge of an adjacent said body of an adjacent said segment; and
said contact between respective said first edges with respective said second edges defining a support preventing said collar from bending into said opening, whereby a distance of said diameter distance is maintained upon forces imparted to opposing sides of said collar.

7. The apparatus for protecting animals from predators, of claim 4 additionally comprising:
said collar in said engaged position locating a said first edge of a body of each said segments in contact with a respective said second edge of an adjacent said body of an adjacent said segment; and
said contact between respective said first edges with respective said second edges defining a support preventing said collar from bending into said opening, whereby a distance of said diameter distance is maintained upon forces imparted to opposing sides of said collar.

8. The apparatus for protecting animals from predators, of claim 5 additionally comprising:
light emitters positioned on at least one of said segments.

9. The apparatus for protecting animals from predators, of claim 6 additionally comprising:
light emitters positioned on at least one of said segments.

10. The apparatus for protecting animals from predators, of claim 7 additionally comprising:
light emitters positioned on at least one of said segments.

11. The apparatus for protecting animals from predators, of claim 2 additionally comprising:
said distal edges of each of said first sidewall and said second sidewall having a concave curve thereon.

12. The apparatus for protecting animals from predators, of claim 3 additionally comprising:
said distal edges of each of said first sidewall and said second sidewall having a concave curve thereon.

13. The apparatus for protecting animals from predators, of claim 4 additionally comprising:
said distal edges of each of said first sidewall and said second sidewall having a concave curve thereon.

14. The apparatus for protecting animals from predators, of claim 5 additionally comprising:
said distal edges of each of said first sidewall and said second sidewall having a concave curve thereon.

15. The apparatus for protecting animals from predators, of claim 6 additionally comprising:
said distal edges of each of said first sidewall and said second sidewall having a concave curve thereon.

16. The apparatus for protecting animals from predators, of claim 7 additionally comprising:
said distal edges of each of said first sidewall and said second sidewall having a concave curve thereon.
